(19) United States
(12) Patent Application Publication
(10) Pub. No.: US 2011/0115213 A1
(43) Pub. Date: May 19, 2011

(54) INSTRUCTION CHART

(76) Inventors: Ryohei Kuriyama, Tokyo (JP); Yoshihiro Takemi, Tokyo (JP)

(21) Appl. No.: 12/671,976

(22) PCT Filed: Jul. 1, 2008
(86) PCT No.: PCT/JP2008/002082

§ 371 Date: Feb. 3, 2010

(30) Foreign Application Priority Data
Aug. 3, 2007 (JP) 2007-202674

(51) Int. Cl. B42D 15/00

(52) U.S. Cl. 283/115

(57) ABSTRACT

An instruction chart for a system is disclosed, wherein the system is operable in accordance with a plurality of operation items, and each of the operation items is categorized into one of operation categories. The instruction chart comprises location symbols, category symbols, item symbols and description areas. The location symbols are indicative of unique names, respectively. Each of the unique names is of a place, a facility, a station or a bus stop. The category symbols are representative of the operation categories, respectively. The category symbols are expressed to be associated with the location symbols, respectively. The item symbols are representative of the operation items, respectively. Each of the item symbols is linked with one of the category symbols in accordance with a relation between the operation item represented by the item symbol and the operation category of the represented operation item. The description areas are expressed to be associated with the item symbols, respectively. Each of the description areas has description for the operation item represented by the associated item symbol.

### TECHNICAL FIELD

This invention relates to an instruction chart for operations of a software system or a hardware system such as an electronic device or a mechanical device, or for maintenance procedures of an institute or a building.

### BACKGROUND ART

Normally, a hardware system or a software system is sold or distributed together with an instruction manual in which operations of the system are described in detail so that a user can refer to the instruction manual to find out how to use the system.

However, recent development of technology provides a system with a large number of functions which cause an instruction manual of the system to be relatively voluminous. The relatively voluminous instruction manual impedes a user to grasp all of the functions of the system. JP-A 2003-211867 discloses an instruction manual that helps a user to easily comprehend how to use a system even if the system has a large number of functions.

### DISCLOSURE OF INVENTION

It is an object of the present invention to provide a new approach to easily grasp all functions of a complicated system.

One aspect of the present invention provides an instruction chart for a system, wherein the system is operable in accordance with a plurality of operation items, and each of the operation items is categorized into one of operation categories. The instruction chart comprises location symbols, category symbols, item symbols and description areas. The location symbols are indicative of unique names, respectively. Each of the unique names is of a place, a facility, a station or a bus stop. The category symbols are representative of the operation categories, respectively. The category symbols are expressed to be associated with the location symbols, respectively. The item symbols are representative of the operation items, respectively. Each of the item symbols is linked with one of the category symbols in accordance with a relation between the operation item represented by the item symbol and the operation category of the represented operation item. The description areas are expressed to be associated with the item symbols, respectively. Each of the description areas has description for the operation item represented by the associated item symbol.

### BRIEF DESCRIPTION OF DRAWINGS

FIG. 1 is an example sheet on which an instruction chart is printed.

FIG. 2 is a view schematically showing an instruction chart in accordance with an embodiment of the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### BEST MODE FOR CARRYING OUT THE INVENTION

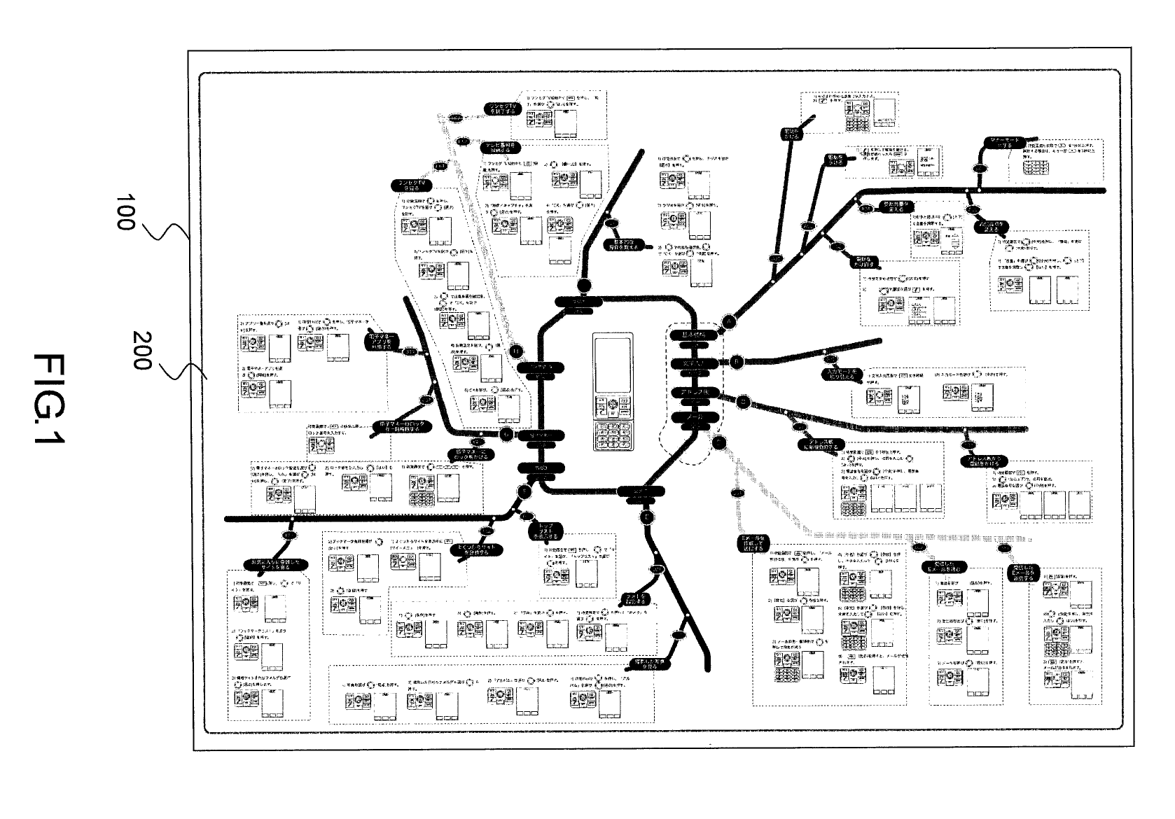

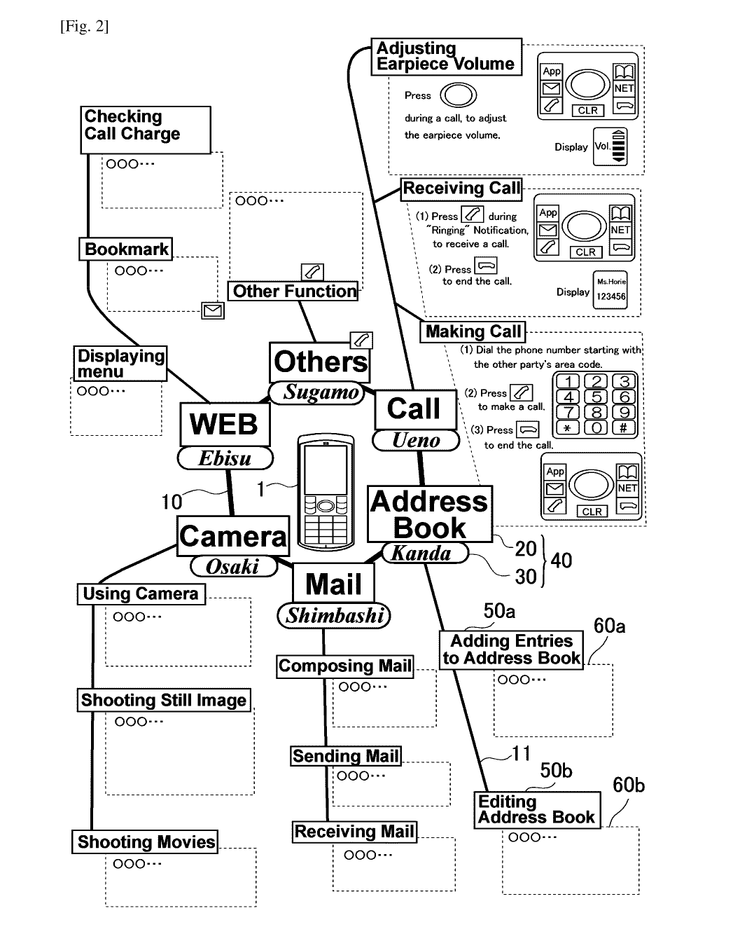

With reference to FIG. 1, an instruction sheet according to an embodiment of the present invention is used to find out how to use a system and comprises a sheet 100 on which an instruction chart 200 is printed. The system can be operated in accordance with a plurality of operation items, each of which is categorized into one of operation categories. The illustrated sheet 100 is made of paper, but the present invention is not limited thereto. For example, the sheet 100 has a laminated structure comprised of a sheet-like base and a film formed on the sheet-like base, wherein the instruction chart is printed on the film. The system of this embodiment is a mobile phone, as symbolized in FIGS. 1 and 2. However, the present invention is not limited thereto. A target system may be a software system or a hardware system such as another electronic device or a mechanical device, or a system installed within an institute or a building.

With reference to FIG. 2, the illustrated instruction chart is based on a railroad map comprising existing railways and existing stations each placed on one of the existing railways. More specifically, the illustrated instruction chart is based on a railroad map for Tokyo Metropolitan Area including “Yamanote Line”; “Ueno”, “Sugamo”, “Ebisu”, “Osaki”, “Shimbashi” and “Kanda” are names of existing stations on “Yamanote Line.”

As shown in FIG. 2, “Yamanote Line” is symbolized into a trunk line 10. The trunk line 10 of the present embodiment has a loop-like shape, within which a symbol 1 of the system of this embodiment, i.e. mobile phone is illustrated.

On the trunk line 10, a plurality of symbol pairs 40 are arranged. Each of the symbol pairs 40 consists of a category symbol 20 and a location symbol 30. On the instruction chart, the category symbol 20 and the location symbol 30 constituting one pair is illustrated in association with each other.

The illustrated instruction chart comprises six category symbols 20 and six location symbols 30. The category symbols 20 represent the operation categories of the mobile phone, respectively: specifically, “Call”, “Address Book”, “Mail”, “Camera”, “WEB”, and “Others.” The location symbols indicate unique names of existing stations, respectively: specifically, “Ueno”, “Sugamo”, “Ebisu”, “Osaki”, “Shimbashi” and “Kanda.” The location symbols 30 are arranged in accordance with the actual configuration of the existing stations. The illustrated location symbols 30 accompany with the category symbols 20, respectively.

From the symbol pairs 40, branch lines 11 extend, respectively. In this embodiment, the branch lines 11 extend radially from the respective symbol pairs 40 on the trunk line 10.

To the branch lines 11, one or more item symbols are connected. The item symbols represent the operation items of the mobile phone, respectively. Each of the item symbols is connected to the branch line extending from the symbol pair of the category symbol linked with the item symbol. For example, two item symbols 50a, 50b are connected to the branch line 11 which extends from the symbol pair 40 of the location symbol 30 of “Kanda” and the category symbol 20 of “Address Book”, wherein the item symbols 50a, 50b correspond to the operation items “Adding Entries to Address Book” and “Editing Address Book”, respectively. Thus, the item symbols 50a, 50b of “Adding Entries to Address Book” and “Editing Address Book” are linked with the category symbol 20 of “Address Book.”

Note here that the operation items “Adding Entries to Address Book” and “Editing Address Book” are categorized into the operation category “Address Book.” A relation between the item symbol 50a and the category symbol 20 therefor corresponds to another relation between the operation item “Adding Entries to Address Book” represented by the item symbol 50a and the category symbol “Address Book” of the represented operation item “Adding Entries to Address Book.” Similarly, still another relation between the item symbol 50b and the category symbol 20 therefor corresponds to yet another relation between the operation item “Editing Address Book” represented by the item symbol 50b and the category symbol “Address Book” of the represented operation item “Editing Address Book.” Thus, each item symbol 50a, 50b is linked with one of the category symbols 40 in accordance with a relation between the operation item represented by the item symbol and the operation category of the represented operation item. Each of the other illustrated item symbols is also linked with one of the category symbols 40 in the same manner.

The illustrated instruction chart further comprises description areas which are expressed to be associated with the item symbols, respectively. For example, the description areas 60a, 60b are coupled with the item symbols 50a, 50b of “Adding Entries to Address Book” and “Editing Address Book”, respectively. The description area 60a has description for the operation item “Adding Entries to Address Book”, while the description area 60b has description for the operation item “Editing Address Book.”

Because of associations of the category symbols 20 and the location symbols 30 based on the existing stations, a user can readily overlook and grasp all of the function categories of the mobile phone even if the user uses the instruction sheet for the first time. In addition, it is easy for the user to remember the associations so that, when the user searches one of the operation items, the user can easily find out the operation item in accordance with the associations.

Although the instruction chart of the above-explained embodiment is based on the railroad map for Tokyo Metropolitan Area, the present invention is not limited thereto. The instruction chart may be based on another railroad map, a bus route map, a subway route map, a highway map, a guide map or the like. Although the trunk line 10 of the above-explained embodiment has a loop-like shape, the present invention is not limited thereto. The trunk line 10 may have another shape such as a straight shape or a curve shape.

Although the location symbols 30 of the above-explained embodiment include the names of the existing stations, the present invention is not limited thereto. The location symbols 30 may be created by symbolizing the existing stations in another manner. The location symbols 30 may be created by symbolizing existing places, existing facilities or existing bus stops.

The instruction chart according to the present invention may be used alone or may be used together with a normal instruction manual of booklet type. In case where the instruction chart and the normal instruction manual are used in combination, the instruction chart may have information about page numbers in the instruction manual so that a user can easily refer to the instruction manual.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

1. An instruction chart for a system that is operable in accordance with a plurality of operation items, each of the operation items being categorized into one of operation categories, the instruction chart comprising:
location symbols indicative of unique names, respectively, each of the unique names being of a place, a facility, a station or a bus stop;
category symbols representative of the operation categories, respectively, the category symbols being expressed to be associated with the location symbols, respectively;
item symbols representative of the operation items, respectively, each of the item symbols being linked with one of the category symbols in accordance with a relation between the operation item represented by the item symbol and the operation category of the represented operation item; and
description areas expressed to be associated with the item symbols, respectively, each of the description areas having description for the operation item represented by the associated item symbol.

2. The instruction chart according to claim 1, further comprising a trunk line and a plurality of branch lines, wherein:
each of the location symbol and one of the category symbols associated therewith constitute a symbol pair;
the symbol pairs are arranged on the trunk line;
the branch lines extend from the symbol pairs, respectively; and
each of the item symbols is connected to the branch line extending from the symbol pair of the category symbol linked with the item symbol.

3. The instruction chart according to claim 2, wherein the trunk line has a loop-like shape.

4. The instruction chart according to claim 2, wherein each of the unique names is of an existing place, an existing facility, an existing station or an existing bus stop.

5. The instruction chart according to claim 4, the instruction chart being based on a railroad map comprising existing railways and existing stations each placed on one of the existing railways, wherein the trunk line corresponds to one of the existing railways, and the unique names are names of the existing stations, respectively.

6. The instruction chart according to claim 1, wherein the location symbols include the unique names, respectively.

7. The instruction chart according to claim 1, the system being a mobile phone.

8. An instruction sheet comprising a sheet on which the instruction chart according to claim 1 is printed.
